(19) United States
(12) Patent Application Publication
(10) Pub. No.: US 2004/0248463 A1
(43) Pub. Date: Dec. 9, 2004

(54) Shaver socket

(76) Inventor: Frederick Charles Cane, Devon (GB)

Correspondence Address: MILES & STOCKBRIDGE PC, 1751 PINNACLE DRIVE, SUITE 500, MCLEAN, VA, 22102-3833, US

(21) Appl. No.: 10/479,803

(22) PCT Filed: Jun. 6, 2002
(86) PCT No.: PCT/GB02/02593

(30) Foreign Application Priority Data
Jun. 7, 2001 (GB) 0113892.4

(51) Int. Cl. H01R 13/60

(52) U.S. Cl. 439/527

(57) ABSTRACT

A shaver socket assembly comprising a fascia plate having attached thereto a housing block and being capable of attachment to a transformer, the fascia plate having plug pin-receiving apertures in registration with electrical contact-containing channels formed in the housing block, in which the fascia plate includes a raised formation including an outwardly-protruding face inclined at an acute angle to the plane of the plate and defining the apertures, the channels having a longitudinal axis at a complementary angle to said acute angle in relation to the plane of the plate, the site of attachment of the transformer being to the rear of the fascia plate behind the raised formation.

This invention relates to shaver sockets.

Conventionally, shaver sockets include a transformer the input side of which is for connection to the mains electrical power supply and a housing block defining channels including electrical contacts for receiving the pins of the shaver plug connected to the output side of the transformer. The transformer and housing block are mounted to the rear of a fascia plate for attachment to a standard surface-mounted or wall-inset box for a power outlet socket. The fascia plate is provided with apertures in registration with the channels in the housing block for providing access to the channels for the plug pins. The apertures are shaped and dimensioned to receive the pins with a sliding fit, access to the electrical contacts when the plug is disengaged being prevented by slidable or pivotable shutters behind the apertures, the shutters being biassed to the closed position and moveable against the bias to the open position by insertion of the pins through the apertures, in known manner. The channels are conventionally arranged orthogonally to the plane of the fascia plate, whereby the plug is offered to the socket with the pins normal to the plate. The housing block thus is required to extend substantially to the full depth of the mounting box to accommodate the longitudinal extent of the pins and the housing is therefore required to be mounted beside the transformer to the rear of the fascia plate, this necessitating the use of a mounting box for a power outlet having a double socket.

It is an object of the present invention to provide a shaver socket which can be mounted in a box intended for a single power outlet socket.

The present invention provides in one aspect a shaver socket assembly comprising a fascia plate having attached thereto a housing block and being capable of attachment to a transformer, the fascia plate having plug pin-receiving apertures in registration with electrical contact-containing channels formed in the housing block, in which the fascia plate includes a raised formation including an outwardly-protruding face inclined at an acute angle to the plane of the plate and defining the apertures, the channels having a longitudinal axis at a complementary angle to said acute angle in relation to the plane of the plate, the site of attachment of the transformer being to the rear of the fascia plate behind the raised formation.

In another aspect, the invention provides a shaver socket assembly comprising a fascia plate having attached thereto a transformer and a housing block, the fascia plate having plug pin-receiving apertures in registration with electrical contact-containing channels formed in the housing block, in which the fascia plate includes a raised formation including an outwardly-protruding face inclined at an acute angle to the plane of the plate and defining the apertures, the channels having a longitudinal axis at a complementary angle to said acute angle in relation to the plane of the plate, the transformer being attached to the rear of the fascia plate behind the raised formation.

In a shaver socket assembly according to the invention, the plug pin channels are accommodated within or substantially within the raised formation, thus enabling the transformer to be attached behind the housing block and the assembly being accommodatable in a single-socket mounting box.

The electrical contacts in the channels formed in the housing block may be connected by traditional wiring to the transformer or may be comprised in a printed circuit board. Safety shutters are preferably provided, resiliently attached to the rear of the fascia plate to blank off the channels when no plug is engaged in the socket. The apertures may be configured to accept a variety of pin shapes and spacings and alternative apertures and channels may be provided for different mains voltage supplies, preferably involving a common aperture and channel for the neutral contact.

The angle of the face to the plane of the plate is preferably approximately 45° or, more preferably, slightly less than 45°, for example 35 to 40°, to keep the overall height of the raised formation above the body of the plate to a minimum while at the same time providing sufficient depth to the raised formation to accommodate the plug pin channels.

Embodiments of the invention will now be described by way of example with reference to the accompanying drawings, of which:

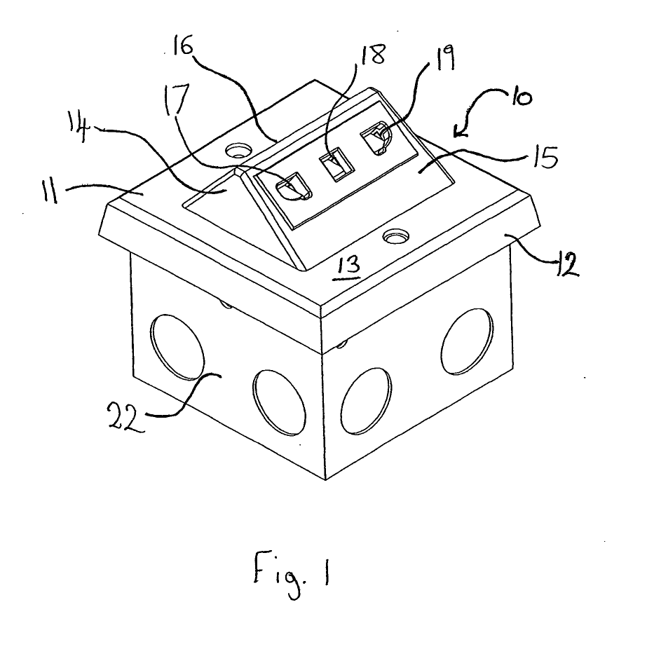

FIG. 1 is a perspective view of a fascia plate and a mounting box for a shaver socket assembly and

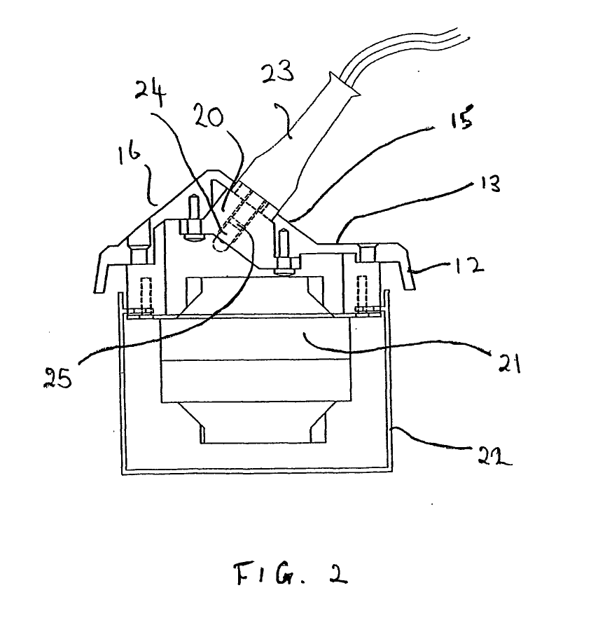

FIG. 2 is a diagrammatic section through an assembly utilising a fascia plate and mounting box as shown in FIG. 1 and with a plug engaged therein.

With reference firstly to FIG. 1, the fascia plate shown generally at 10 has a base 11 with a peripheral skirt 12, the base being suitable for attachment to a conventional mounting box 22 of the type suitable for embedding in a wall, with the lip of the skirt 12 in contact with the wall surface. Extending outwardly from the front-facing flat surface 13 of the fascia plate is a raised formation 14 having faces 15, 16 each at an angle of 40° to the plane of the fascia plate as represented by the surface 13. Angled face 15 includes apertures 17, 18, 19 for receiving the pins of a shaver plug; aperture 18 is a common aperture connected to the return or neutral connector beneath the aperture, as shown more clearly in FIG. 2, whereas apertures 17 and 19 are respectively for different mains voltage supply levels, typically 115V and 230V.

With reference now to FIG. 2, the fascia plate is shown having attached thereto a housing block 20 and a transformer 21, the entire assembly being secured within the mounting box 22. A plug 23 is shown with its pins 24 engaged through the apertures in channels formed in the housing block and containing electrical connectors 25 which are operatively connected to the transformer 21. The transformer is permanently connected to the domestic mains supply.

As shown, the angled disposition of the pins 24 enables them to be accommodated withiu the fascia plate at a lower overall depth requirement than with conventional fascia plate assemblies, allowing the transformer to be mounted directly beneath the housing block and the entire assembly to be accommodated, as shown, within a single-socket outlet mounting box 22.

1. A shaver socket assembly comprising a fascia plate having attached thereto a housing block and being capable of attachment to a transformer, the fascia plate having plug pin-receiving apertures in registration with electrical contact-containing channels formed in the housing block, in which the fascia plate includes a raised formation including an outwardly-protruding face inclined at an acute angle to the plane of the plate and defining the apertures, the channels having a longitudinal axis at a complementary angle to said acute angle in relation to the plane of the plate, the site of attachment of the transformer being to the rear of the fascia plate behind the raised formation.

2. A shaver socket assembly according to claim wherein the angle of the face to the plane of the plate is approximately 45°.

3. A shaver socket assembly according to claim 1 wherein the angle of the face to the plane of the plate is slightly less than 45°.

4. A shaver socket assembly according to claim 3 wherein the angle of the face to the plane of the plate is approximately 35° to 40°.

5. A shaver socket assembly according to claim 1 including a transformer attached to the rear of the fascia plate behind the raised formation.

6. A shaver socket assembly according to claim 5 in which the electrical contacts in the channels formed in the housing block are connected by wiring to the transformer.

7. A shaver socket assembly according to claim 5 in which the electrical contacts in the channels formed in the housing block are comprised in a printed circuit board.

8. A shaver socket assembly according to claim 1 including safety shutters resiliently attached to the rear of the fascia plate to blank off the channels when no plug is engaged in the socket.

9. A shaver socket assembly according to claim 1 having alternative apertures and channels for different mains voltage supplies.

10. A shaver socket assembly according to claim 9 having a common aperture and channel for the neutral contact.

11. A shaver socket assembly comprising a fascia plate having attached thereto a transformer and a housing block, the fascia plate having plug pin-receiving apertures in registration with electrical contact-containing channels formed in the housing block, in which the fascia plate includes a raised formation including an outwardly-protruding face inclined at an acute angle to the plane of the plate and defining the apertures, the channels having a longitudinal axis at a complementary angle to said acute angle in relation to the plane of the plate, the transformer being attached to the rear of the fascia plate behind the raised formation.
